(19) United States
(12) Patent Application Publication
(10) Pub. No.: US 2025/0299291 A1
(43) Pub. Date: Sep. 25, 2025

(54) METHOD FOR IMAGE ENHANCEMENT AND IMAGE-ENHANCEMENT PROCESSING SYSTEM

(71) Applicant: REALTEK SEMICONDUCTOR CORP., HSINCHU (TW)

(72) Inventors: TIEN-HUNG LIN, HSINCHU (TW); CHIA-WEI YU, HSINCHU (TW); JIA-MEI FENG, Jiangsu Province (CN)

(21) Appl. No.: 19/079,635

(22) Filed: Mar. 14, 2025

(30) Foreign Application Priority Data
Mar. 20, 2024 (CN) 202410323197.6

(51) Int. Cl. G06T 3/40; G06T 5/40; G06T 5/90; G06T 7/50

(52) U.S. Cl. CPC G06T 3/40; G06T 5/40; G06T 5/90; G06T 7/50; G06T 2207/20132; G06T 2207/20208; G06V 2201/07

(57) ABSTRACT

A method for image enhancement and an image-enhancement processing system are provided. In the method, an input video with an original resolution is obtained. The input video is frame-by-frame cropped into a selected video with an output resolution according to setting of an output video. The selected video is saved to a memory. On the other hand, enhancement preprocessing is performed on each frame of the selected video, so as to form multiple layers of downscaled images with different reduced proportions. One or more image-enhancement-processing processes are performed on the multiple layers of downscaled images. After that, enhancement post-processing is performed on the multiple layers of downscaled images, so that these downscaled images in each frame of the selected video are mapped to be mapping-layer images with the output resolution. Lastly, the mapping-layer images and the selected video are frame-by-frame composed, so as to generate the output video.

### CROSS-REFERENCE TO RELATED PATENT APPLICATION

This application claims the benefit of priority to China Patent Application No. 202410323197.6, filed on Mar. 20, 2024, in the People's Republic of China. The entire content of the above identified application is incorporated herein by reference.

Some references, which may include patents, patent applications and various publications, may be cited and discussed in the description of this disclosure. The citation and/or discussion of such references is provided merely to clarify the description of the present disclosure and is not an admission that any such reference is “prior art” to the disclosure described herein. All references cited and discussed in this specification are incorporated herein by reference in their entireties and to the same extent as if each reference was individually incorporated by reference.

### FIELD OF THE DISCLOSURE

The present disclosure relates to an image-enhancement processing technology, and more particularly to a method for image enhancement and an image-enhancement processing system that configure a cropping time for keeping settings of firmware or software for image enhancement processing to be consistent.

### BACKGROUND OF THE DISCLOSURE

When watching a video, a user can instruct a display system to capture a screen image of the video. A processor of the display system is required to identify the size of the screen image if the image quality is considered. Therefore, the processor can correctly convert the image only if the video records complete information of the size of original images.

The display system is, for example, a television system. When the display system receives the video, the user can instruct the display system to capture a part of the screen image (not the original image) during playing of the video. For example, only the part of the screen image can be captured because the original images are processed by an overscan process or cropped. Therefore, the following image-processing process may not be performed on the images with an original size. However, most image-enhancement-processing processes (e.g., a high-dynamic-range (HDR) imaging process) that require high image quality need to accurately identify the size of the images, or even only process the video with an original size.

Reference is made to FIG. 1, which is a flow diagram illustrating a video enhancement-processing process.

In the process, an input video 101 received by a video enhancement-processing circuit has a dimension of 3,840×2,160 (pixels). Based on the requirement of an input end, a video that is configured to be composed and outputted (e.g., a selected video 115 shown in the diagram) can be obtained from the input video 101. On the other hand, the video can be frame-by-frame processed by an enhancement preprocessor 103 in an enhancement layer 105. For example, a frame with a dimension of 3,840×2,160 (pixels) is adjusted into multiple small pictures, e.g., small pictures with dimensions of 1,920×1,080 (pixels), 960×540 (pixels), and 480×270 (pixels). These small pictures are provided for various image-processing processes, such as image-contrast processing, noise reduction, and high-dynamic-range (HDR) imaging. The main objective of the video enhancement-processing process is to obtain the images with a better quality.

After the images are processed through the image-processing processes, multiple images in different resolutions are processed by an enhancement postprocessor 107, in which a mapping method is performed to restore the images to have the same size as that of the original images in a mapping layer 109. For example, the size of the original images is 3,840×2,160 (pixels). Lastly, a composer 111 is used to compose the images that undergo the enhancement-processing process and the mapping process with the selected video 115 to be an output video 113.

Reference is made to FIG. 2, which is a flow diagram illustrating another video enhancement-processing process. When there is a need to capture a part of an image (e.g., the image is required to be adjusted to have a ratio of 4:3 or 16:9 for output) in a back-end device (e.g., a television), the video enhancement-processing circuit needs to adjust the images processed by an enhancement preprocessor 205 and an enhancement postprocessor 209 to be same-sized images.

In the present example, the video enhancement-processing circuit receives an input video 201 with an original size of 3,840×2,160 (pixels). Since an output end requires an output video 217 with an aspect ratio of 16:9 and a size of 3,712×2,096 (pixels), the video enhancement-processing circuit crops the input video 201 to be a selected video 219 with a corresponding size and a corresponding aspect ratio in a cropping process 203. After frame-by-frame cropping the input video 201 to be the images with an appropriate size, the cropped images are inputted to the enhancement preprocessor 205, and the enhancement preprocessor 205 processes the cropped images to be the images in an enhancement layer 207.

For example, the images formed in the enhancement layer 207 include multiple small images that have sizes of 1,856×1,048 (pixels), 928×524 (pixels), and 464×262 (pixels), respectively. These small images are processed by various image-enhancement-processing processes for enhancing the image quality. The images are then inputted to the enhancement postprocessor 209 for mapping, so that the small images processed in the enhancement layer 207 are mapped to be images having the same size as that of the selected video in a mapping layer 211. Here, the size is 3,712×2,096 (pixels). Finally, a composer 215 composes the images that undergo the enhancement processing and mapping with the selected video to be the output video 217. Here, the output video 217 has the aspect ratio of 16:9 and the size of 3,712×2,096 (pixels).

Since the enhancement preprocessor 205 is used to process the entire video for forming the enhancement layer 207, a process of frame delay 213 is required to be performed on the cropped input video, so as to generate the selected video 219 that is configured to be composed with the enhanced images. On the other hand, in order for the images in the mapping layer 211 to be aligned with the selected video, a frame delay process is required to be performed on the images in the mapping layer 211. In this way, the images in the mapping layer 211 can be composed with the selected video in the composer 215, so as to generate the output video 217.

FIG. 3 is a schematic diagram showing a time sequence of images processed by the video enhancement-processing circuit in different stages.

Compared with the flow diagram shown in FIG. 2, FIG. 3 shows a time sequence of the input video 201, the selected video 219, the enhancement layer 207, the mapping layer 211, and the output video 217. Each frame A to G in the input video 201 is processed by the enhancement preprocessor 205 for generating the images in the enhancement layer 207. As a result, there is a delay between every two frames in the enhancement postprocessor 209. The images in the mapping layer 211 are aligned, and can be composed with the selected video 219 when the frames in the selected video 219 are processed through frame delay.

As shown in the diagram, the frames in the selected video 219 are delayed by one frame time as compared with the input video 201. In an exemplary example, the user can use a remote control to adjust an aspect ratio of the video from 4:3 to 16:9 or to a movie expansion format when the video is played. The diagram shows that the frames C and D in the selected video 219 are adjusted to have different aspect ratios, and are then adjusted back to the same aspect ratio. The images in the enhancement layer 207 are generated only when the enhancement preprocessor 205 processes every frame of the input video 201, such as processing only a part of the frames of the input video 201, or downscaling the frames. Accordingly, pixel delays or line delays formed by scan lines are present between frames A* to F* in the enhancement layer 207 and the frames A to G in the original input video 201.

The images are then processed by a mapping process in the enhancement postprocessor 209, so that frames A** to F** are formed in the mapping layer 211. In the meantime, the frames A** to F** in the mapping layer 211 can be aligned with the frames A to F in the selected video 219 through frame delay.

However, based on the above-mentioned conventional technology, since multiple layers of different reduced images in the enhancement layer are required to be adjusted to have the same proportion, and coordinates of the pixels cannot completely correspond when the reduced image is mapped for magnification (due to the coordinates of the pixels of the original image in the input video being not divisible when the original image is reduced), setting up the circuits can be difficult. In addition, since the image received by the enhancement preprocessor may be a cropped image, it is difficult to perform the enhancement processing if the neural network technology is adopted and modification of training data is required.

### SUMMARY OF THE DISCLOSURE

In response to the above-referenced technical inadequacies of the conventional image-enhancement processing technology in a display system, the present disclosure provides a method for image enhancement and an image-enhancement processing system. The image-enhancement processing system employs multiple cropping processes in the method for image enhancement, so that an image-enhancement circuit can identify the size of images before the images are cropped. After the images are cropped, the images can still be mapped to have the same size as that of a selected video for conveniently setting up the image-enhancement circuit and performing the following processes.

The image-enhancement processing system implements an enhancement preprocessor, an enhancement postprocessor, and a composer through collaboration of firmware and software or in cooperation with hardware. In an embodiment of the method for image enhancement, an input video with an original resolution is firstly obtained, and the input video is frame-by-frame cropped to generate a selected video with an output resolution according to setting of the output video. The selected video is then saved to a memory.

Next, an enhancement preprocessing process is performed on each of frames of the selected video, and the frame becomes one or more layers of downscaled images with different reduced proportions. Afterwards, one or more image-enhancement-processing processes are performed on the one or more layers of downscaled images with different reduced proportions. An enhancement post-processing process is then performed on the one or more layers of downscaled images. According to the setting of the output video, the one or more layers of downscaled images with different reduced proportions in each of the frames are mapped to be mapping-layer images with the output resolution. The mapping-layer images are frame-by-frame composed with the selected video saved in the memory, so as to form the output video.

Further, the enhancement preprocessing process includes a procedure of establishing a histogram for each of the frames, performing high-dynamic-range imaging, and/or enhancing image quality.

In addition, the enhancement preprocessing process also includes the one or more image-enhancement-processing processes obtained by training image data with a neural network. The image-enhancement-processing processes include processes of determining a depth of each of the frames, determining objects in the frame, and/or detecting a resolution of the frame.

Further, after the mapping-layer images are aligned by a frame delay process, the selected video that is obtained by cropping the input video is composed with the mapping-layer images that are continuously obtained by a mapping process.

Preferably, the method for image enhancement is performed by firmware of an image-processing device. The firmware implements an enhancement preprocessor for performing enhancement preprocessing, an enhancement postprocessor for performing enhancement post-processing, and a composer used to frame-by-frame compose the mapping-layer images and the selected video.

The firmware relies on the setting of the output video to determine a scaling proportion between the images respectively processed by the enhancement preprocessor and the enhancement postprocessor.

Further, the image-processing device is controlled by a controller. The controller issues an instruction for setting up the output video, and the instruction enables switching of the output resolution of the output video.

In an aspect of the present disclosure, the firmware includes a pseudo timing generator that issues a control signal to the enhancement postprocessor in advance. The enhancement postprocessor can therefore retrieve the one or more layers of downscaled images with different reduced proportions in advance, and perform the enhancement post-processing process on the one or more layers of downscaled images.

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The described embodiments may be better understood by reference to the following description and the accompanying drawings, in which:

FIG. 1 is a flow diagram illustrating a video enhancement-processing process of a conventional technology;

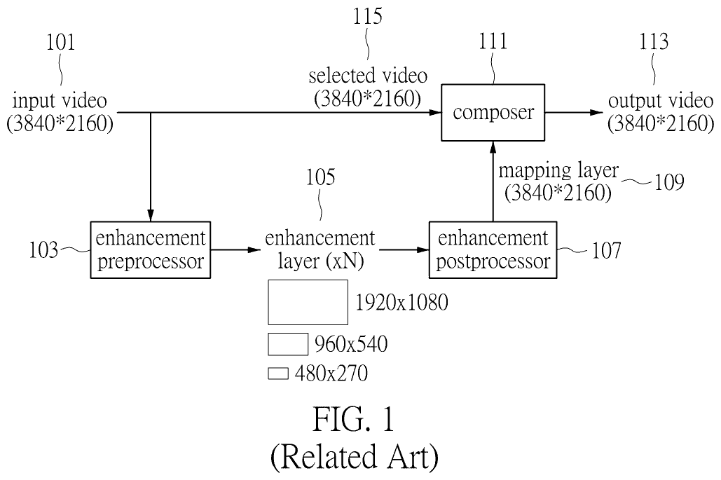

FIG. 2 is a flow diagram illustrating another video enhancement-processing process of the conventional technology;

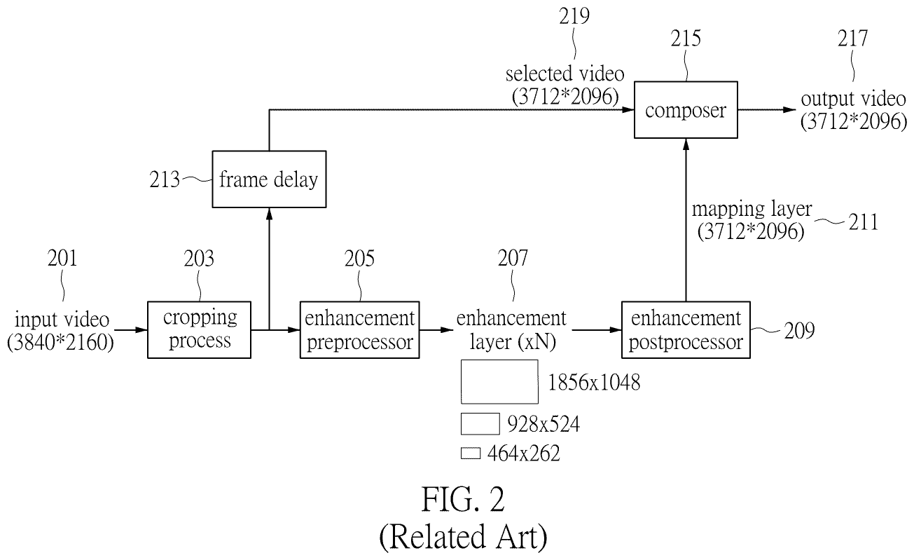

FIG. 3 is a schematic diagram showing a time sequence of images processed by a conventional video enhancement-processing circuit in different stages;

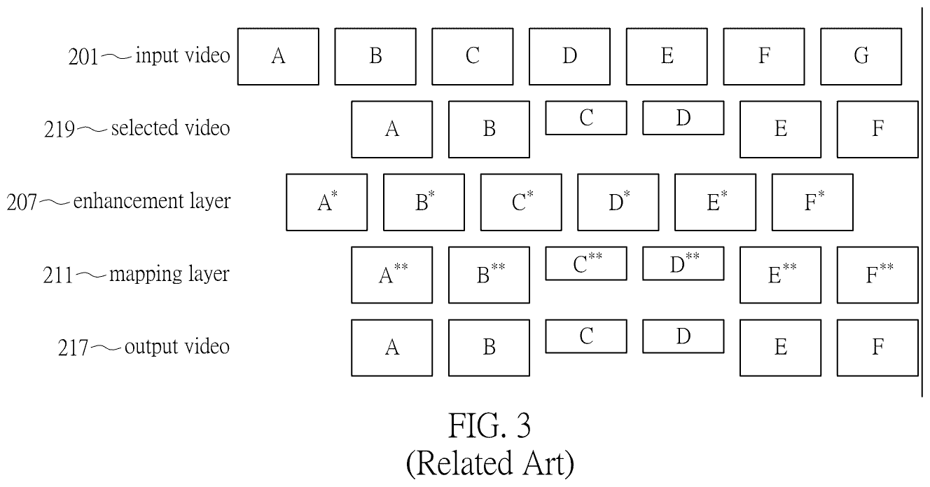

FIG. 4 is a schematic diagram depicting a system that applies a method for image enhancement according to one embodiment of the present disclosure;

FIG. 5 is a flowchart illustrating the method for image enhancement according to one embodiment of the present disclosure;

FIG. 6 is a schematic diagram illustrating an image-enhancement processing system that performs the method for image enhancement according to one embodiment of the present disclosure;

FIG. 7 is a flow diagram illustrating an image-enhancement-processing process operated in firmware according to one embodiment of the present disclosure;

FIG. 8 is a schematic diagram depicting an image that is cropped by a cropping process;

FIG. 9 is another schematic diagram depicting the image that is cropped by the cropping process in a time domain; and

FIG. 10 is another flow diagram illustrating the image-enhancement-processing process operated in the firmware according to one embodiment of the present disclosure.

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a,” “an” and “the” includes plural reference, and the meaning of “in” includes “in” and “on.” Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first,” “second” or “third” can be used to describe various components, signals or the like, which are for distinguishing one component/signal from another one only, and are not intended to, nor should be construed to impose any substantive limitations on the components, signals or the like.

In order to solve the problems of a conventional image-enhancement processing method, the present disclosure provides an improved method for image enhancement and a system performing the method. Particularly, the system is a system used for processing continuous images (e.g., a set-top box (STB)). The method for image enhancement can be applied to firmware used to process images. The above-mentioned problems may occur in a process of image enhancement. For example, many layers of downscaled images with different reduced proportions are generated in an enhancement layer, and the firmware of the system needs to set up parameters based on the different reduced proportions. If coordinate points of an original image cannot be downscaled by a specific proportion, there will be a problem that the coordinate points cannot be matched completely after the coordinate points are downscaled and then magnified by a mapping process. Further, when an enhancement preprocessor processes images, the enhancement preprocessor receives cropped images having resolutions that are also changed in this stage. As such, data to be trained by a neural network needs to be modified, and processing difficulty may occur.

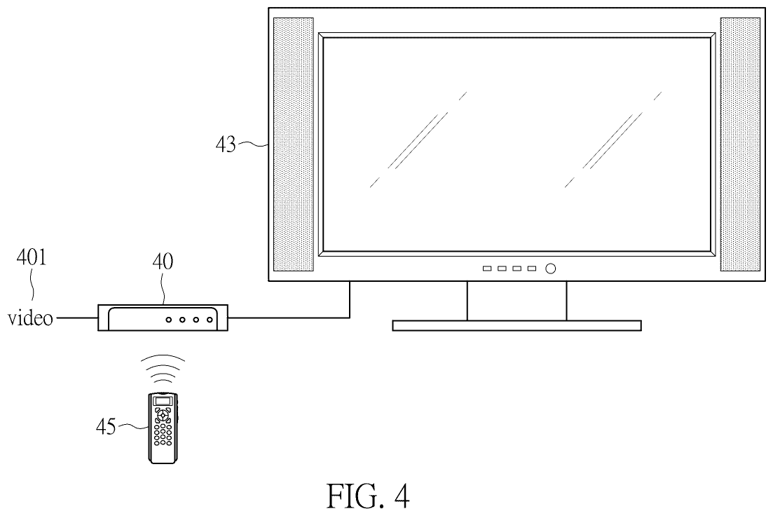

Reference is made to FIG. 4, which is a schematic diagram illustrating a system applying the method for image enhancement according to one embodiment of the present disclosure.

The diagram shows a system that is used to process and display images in one embodiment of the present disclosure. The system includes an image-processing device 40, such as a set-top box (STB) that is used to process audiovisual streaming data. The image-processing device 40 includes an image-enhancement processing system, and connects with a display 43 that can be a television. After the image-processing device 40 receives a video 401, the video 401 is decoded and processed by an image-enhancement process. An output video is then generated and outputted to the display 43 for displaying. When the image-processing device 40 is in operation, the image-processing device 40 is controlled by a controller. The controller issues an instruction of setting up the output video. For example, a user may manipulate a remote control 45 to control images, such as adjusting a resolution and a proportion of the images to be played or retrieving a part of the image.

In certain embodiments of the method for image enhancement provided by the present disclosure, an enhanced video can be properly composed with the original images before being outputted. If a user adjusts a resolution and an aspect ratio (e.g., a horizontal length×a vertical height) of the video to be played in the process of image enhancement, several cropping processes can be used in the method for image enhancement. In this way, an image-enhancement circuit can identify an image size before the video is cropped. After the video is cropped, the image size of the mapped images becomes the same as that of a selected video, so that the image-enhancement circuit can easily set up parameters and process data.

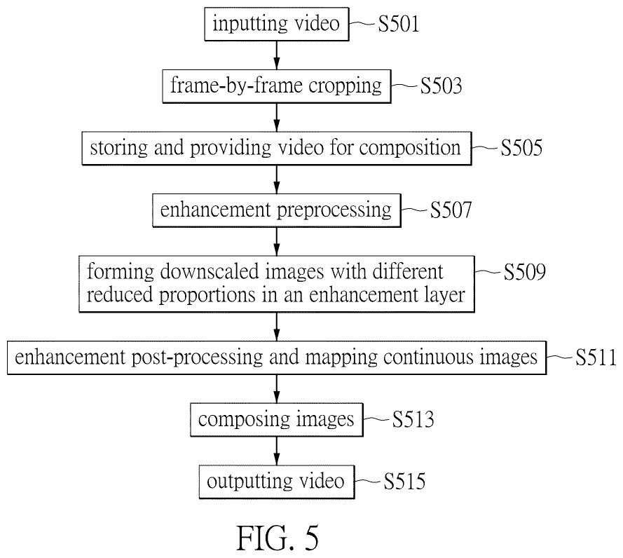

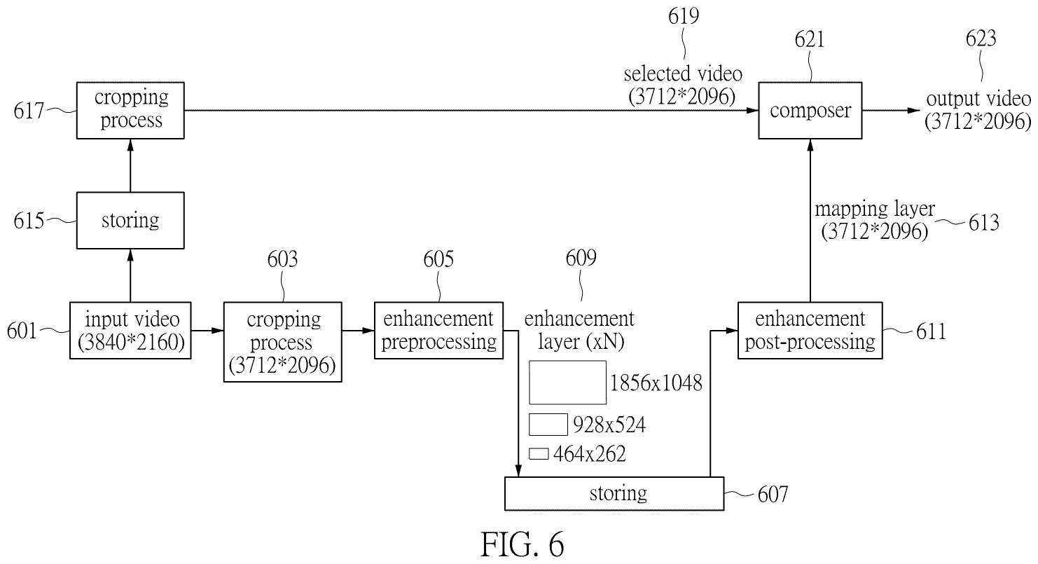

In the imaging system of the above-mentioned embodiment, the image-processing device 40 performs the method for image enhancement through collaboration of firmware, software, and/or hardware. The firmware can be a sequence performed in a system-on-chip (SoC). Taking an enhancement preprocessor, an enhancement preprocessor, and a composer that perform an enhancement-processing process as an example, the firmware or software is in charge of calculating a quantity of layers and sizes of the layers, and these parameters can be converted into configurations applied to a hardware circuitries. Lastly, the circuitry in the image-processing device 40 specifically performs the enhancement-processing process. Reference is made to FIG. 5, which is a flowchart illustrating the method for image enhancement according to one embodiment of the present disclosure. Reference is also made to FIG. 6, which is a schematic diagram depicting an image-enhancement processing system that performs the method for image enhancement according to one embodiment of the present disclosure.

In the beginning, the image-enhancement processing system receives an input video (601) (step S501). The input video (601) that has continuous frames can be downloaded in a streaming manner. The continuous frames have an original resolution of 3,840 pixels by 2,160 pixels (which represent a horizontal length and a vertical height). Next, according to the setting of the output video (623), a cropping process (603) is performed on the input video (601) for frame-by-frame cropping the input video (601) to be a selected video (619) with a specific output resolution (step S503). The selected video (619) has an output resolution of 3,712×2,096 (pixels), and is saved in a memory. The selected video (619) is provided as a video for composing purposes (step S505). It should be noted that the image-enhancement processing system relies on the setting of the output video to determine a scaling proportion between the images that are respectively processed by the enhancement preprocessor and the enhancement postprocessor.

The selected video (619) saved in the memory is used to be composed for generating the output video. On the other hand, the selected video obtained by the cropping process can also be used for enhancement preprocessing, in which the enhancement preprocessor performs enhancement preprocessing (605) on each of the frames of the selected video (step S507). During the enhancement preprocessing (605), each of the frames forms one or more layers of downscaled images with different reduced proportions (step S509). The one or more layers of downscaled images with different reduced proportions are firstly stored (607) to the memory, so as to form an enhancement layer (609) that includes multiple layers of images. In the present example, the enhancement layer (609) includes multiple layers of downscaled images with different reduced proportions, and resolutions of the downscaled images can respectively be 1,856×1,048 pixels, 928×524 pixels, and 464×262 pixels. Afterwards, one or more image-enhancement-processing processes are performed on the one or more layers of downscaled images with different reduced proportions.

The image-enhancement-processing process performed in the enhancement preprocessing includes a procedure of establishing a histogram for each of the frames, performing high-dynamic-range imaging, and/or other approaches of enhancing image quality (such as contrast adjustment, saturation processing, and noise reduction).

In an aspect of the present disclosure, the enhancement preprocessor of the system needs to identify an original size of the image for performing enhancement preprocessing on the one or more layers of downscaled images with different reduced proportions generated in each of the frames of the video. One of the methods is to apply a neural network technology to acquire depth information by analyzing the image, detect objects in the image, and detect an original resolution. Further, the enhancement preprocessor also performs statistics on the entire image for establishing a histogram.

After the process of enhancement preprocessing, the enhancement layer (609) having multiple layers of images is formed and stored (607) in the memory. Next, the enhancement postprocessor performs enhancement post-processing (611). According to the setting of the output video, continuous frames with the output resolution are generated by mapping the one or more layers of downscaled images with different reduced proportions formed in each frame. The present example shows multiple mapping-layer images with a resolution of 3,712×2,096 (pixels) in a mapping layer (613) (step S511).

Next, a composing process is performed by a composer (621) (step S513). When the image-enhancement processing system receives the input video (601), the input video (601) is firstly stored (615) to a memory. In the composing process, the selected video (619) with a resolution of 3,712×2,096 (pixels) is obtained by cropping the input video (601) with a cropping process (617). The composer (621) frame-by-frame composes the mapping-layer images and the selected video saved in the memory (step S513), so as to generate the output video (623) (step S515). The output resolution of the output video (623) is in accordance with the setting of the output resolution, which can be 3,712×2,096 (pixels).

It should be noted that, in the image-enhancement processing system shown in FIG. 6, a frame delay is present between the cropping process (603) performed on the input video (601) and the cropping process (617) in the composing process. Therefore, the firmware needs to perform different cropping processes with different sizes at the same time. Further, the system can firstly store the input video (601) to the memory, and then performs the cropping process (617). However, this approach may consume more memory.

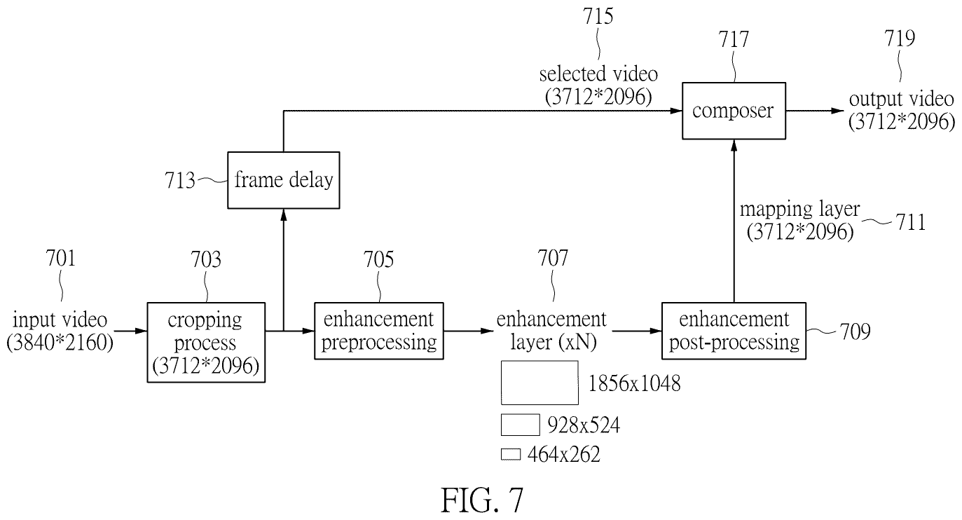

Reference is made to FIG. 7, which is a flow diagram illustrating the process of image enhancement operated in the image-enhancement processing system according to one further embodiment of the present disclosure.

As shown in FIG. 7, the image-enhancement processing system receives an input video 701 with an original resolution of 3,840×2,160 (pixels) from a source. A cropping process 703 is performed on the input video 701, so as to generate a selected video 715 with a resolution of 3,712×2,096 (pixels). The selected video 715 is firstly saved to a memory, and then is used for a process of enhancement preprocessing 705. According to setting of an output video (e.g., an output resolution of 3,712×2,096 pixels), an enhancement layer 707 having multiple layers of images with different scaling proportions can be generated. The multiple layers of images have different resolutions, such as 1,856×1,048 (pixels), 928×524 (pixels) and 464×262 (pixels). After that, a process of enhancement post-processing 709 is performed on the multiple layers of images, so as to map these downscaled images to be the images with the resolution of an output video 719 (i.e., the images with the resolution of 3,712×2,096 (pixels) formed in a mapping layer 711).

On the other hand, the input video 701 is processed by the cropping process 703 and then stored into a memory. The cropped input video 701 is processed by a frame delay process 713 in a composing procedure. It should be noted that, after the mapping-layer images are aligned by the frame delay process 713, the selected video 715 obtained by cropping the input video 701 can be composed with the mapping-layer images that are continuously obtained by a mapping process. Thus, the selected video 715 can be aligned with the images in the mapping layer 711. A composer 717 is used to compose the selected video 715 and the images in the mapping layer 711, so as to obtain the output video 719 with an output resolution of 3,712×2,096.

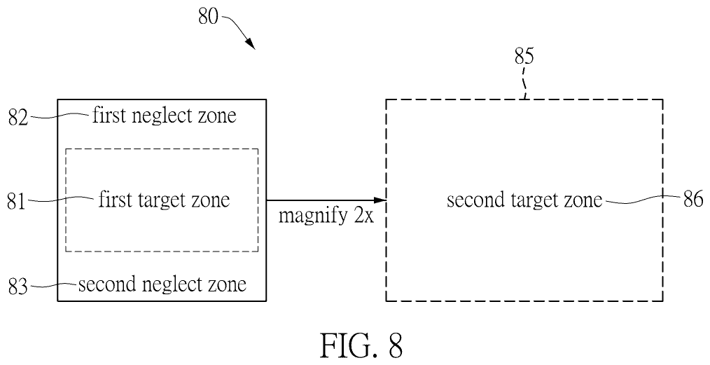

In the above-mentioned process of image enhancement, when a process of enhancement preprocessing is performed on one or more layers of downscaled images with different reduced proportions in each of the frames of the input video, the enhancement preprocessor does not perform the cropping process if identification of the original resolution of the images is required for calculation. This means that the images in the enhancement layer are the multiple layers of images to be downscaled with a specific proportion. Reference is made to FIG. 8, which is a schematic diagram showing an image undergoing the cropping process. An image 80 that includes a first target zone 81, a first neglect zone 82, and a second neglect zone 83 has been cropped in the enhancement layer.

One of the frames in one of the multiple layers of images that are downscaled in proportions from the original image is shown as the image 80. When being processed by the cropping process, the image 80 is cropped as required to form the first target zone 81, and the first neglect zone 82 and the second neglect zone 83 that are formed above and below the first target zone 81. In addition to the first neglect zone 82 and the second neglect zone 83 that are configured to be cropped, zones at the left and the right of the first target zone 81 are possibly to be cropped.

As shown in the diagram, according to the size of the output video, the frame is cropped to obtain the first target zone 81, and the first target zone 81 is mapped to be an active image 85, namely a second target zone 86 where both a horizontal length and a vertical height are magnified by a specific proportion.

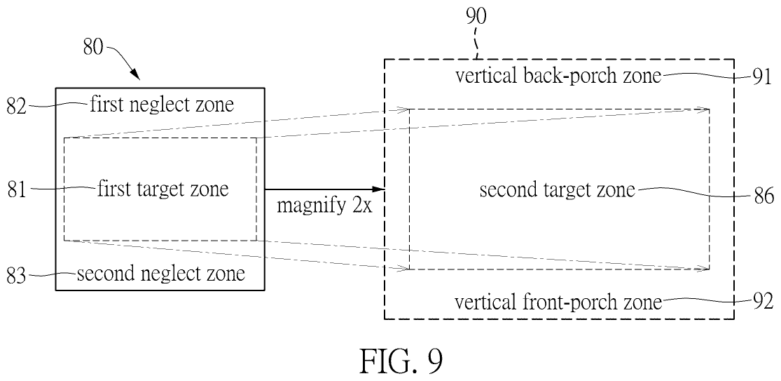

FIG. 9 is a schematic diagram depicting an image undergoing a cropping process in a time domain. The image 80 shown in FIG. 8 is cropped to obtain the first target zone 81, the first neglect zone 82, and the second neglect zone 83 that are magnified with a specific proportion (e.g., twice), so as to generate an image 90 shown in FIG. 9. The image 90 includes the second target zone 86 (which has been magnified twice in its horizontal length and vertical height). Apart from an active zone of the second target zone 86, an upper area of the second target zone 86 has a vertical back porch zone 91, and a lower area of the second target zone 86 has a vertical front porch zone 92. In addition, left and right areas of the second target zone 86 have a horizontal front porch and a horizontal back porch that are not labeled in the diagram.

In the method for image enhancement, multiple layers of downscaled images are formed in the enhancement layer. After that, in the enhancement layer, the enhancement postprocessor performs mapping on the downscaled images to be the images in the mapping layer according to the requirement of output video.

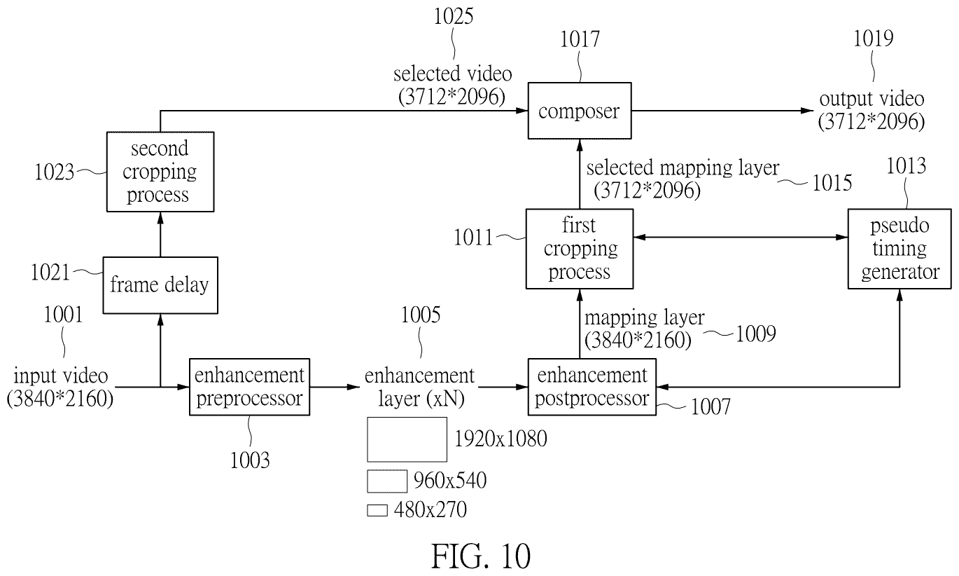

For certain embodiments, reference can be made to FIG. 10, which illustrates the process of image enhancement performed in the image-enhancement processing system that is implemented through collaboration of firmware, software, and/or hardware.

In the process shown in FIG. 10, the image-enhancement processing system receives an input video 1001 that has an original resolution of 3,840×2,160 (pixels in length and height). Before the images of the input video 1001 are cropped, the input video 1001 is inputted to an enhancement preprocessor 1003, so as to generate multiple layers of downscaled images with different reduced proportions in an enhancement layer 1005. The present example shows that the images of the input video 1001 with the original resolution are downscaled in proportions to be multiple downscaled images with resolutions of 1,920×1,080 (pixels), 960×540 (pixels), and 480×270 (pixels), respectively. After one or more image-enhancement-processing processes are performed on the downscaled images, the processed images are inputted to an enhancement postprocessor 1007.

The enhancement postprocessor 1007 performs enhancement post-processing that maps the multiple layers of downscaled images with different reduced proportions in the enhancement layer 1005 to be the images in a mapping layer 1009. A resolution of the mapping-layer images is consistent with the original resolution (e.g., 3,840×2,160 pixels). Next, the mapping-layer images are cropped by a first cropping process 1011 to have a resolution (e.g., 3,712×2,096 pixels) that is consistent with that of an output video 1019.

In the process of enhancement post-processing, the image-enhancement processing system provides a pseudo timing generator 1013 that is used to generate a control signal for controlling the system to operate in several stages. The pseudo timing generator 1013 can be used to avoid problems occurring to composing images due to a pixel delay or a line delay in the process. For example, the pseudo timing generator 1013 can issue a control signal to the enhancement postprocessor 1007 in advance when the system is in operation. Accordingly, the enhancement postprocessor 1007 can acquire the one or more downscaled images with different reduced proportions formed in the frame in advance. The downscaled images can be multiple layers of images. After the enhancement post-processing is completed, an acknowledge (ACK) signal is sent to the pseudo timing generator 1013, and the pseudo timing generator 1013 controls the system to perform the first cropping process 1011 in response to the control signal, so as to form the images with the output resolution of 3,712×2,096 (pixels) in a selected mapping layer 1015.

In an exemplary example, the enhancement post-processing with mapping magnification of two times is taken as an example. Referring to FIG. 8 and FIG. 9, the pseudo timing generator 1013 shown in FIG. 10 can be used to determine the neglect zones (such as the first neglect zone 82 and the second neglect zone 83 shown in FIG. 8) based on vertical and horizontal time sequences. Therefore, there is no need to detect the target area (such as the first target zone 81 shown in FIG. 8). More specifically, in a time domain, a vertical back porch (e.g., the vertical back porch zone 91) and a vertical front porch (e.g., the vertical front porch zone 92) are referred to for determining that the pixels within the neglect zones are completely processed in accordance with the original images without considering or aligning with a display time sequence. Since the neglect zones are configured to be cropped, the vertical back porch and the vertical front porch can be processed more quickly, and the vertical active zone (such as the first target zone 81 of FIG. 8) is processed to be aligned with the display time sequence when the display time sequence reaches the vertical active zone, so as to output the corresponding pixels.

Before the images are composed, the input video 1001 to be initially received is processed by a frame delay 1021 and a second cropping process 1023 for forming a selected video 1025 with an output resolution of 3,712×2,096 (pixels). The selected video 1025 is prepared to be composed. Lastly, the selected video 1025 and the images in the selected mapping layer 1015 are frame-by-frame composed by a composer 1017, so as to generate the output video 1019 that has a resolution of 3,712×2,096 (pixels).

In conclusion, according to the above embodiments of the method for image enhancement and the image-enhancement processing system provided by the present disclosure, the design of a cropping time allows the settings of the firmware or software for image enhancement-processing to be consistent. The process of enhancement preprocessing can be performed on the images before or after the images are cropped. The memory of the system can be saved if the process of enhancement preprocessing is performed on the images that are already cropped. Further, since the frame delay may occur when the process is performed on the original images or the cropped images, the system actively performs the frame delay before the images are composed. Furthermore, the system can use the pseudo timing generator to control operational timing of certain processes, so as to prevent the problem of out-of-sync processes.

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A method for image enhancement, comprising:
obtaining an input video with an original resolution;
frame-by-frame cropping the input video according to setting of an output video, so as to generate a selected video with an output resolution and save the selected video into a memory;
performing enhancement preprocessing on each of frames of the selected video for forming one or more layers of downscaled images with different reduced proportions in each of the frames, and then performing one or more image-enhancement-processing processes on the one or more layers of downscaled images with different reduced proportions;
performing enhancement post-processing according to the setting of the output video for mapping the one or more layers of downscaled images with different reduced proportions to be mapping-layer images with the output resolution; and
frame-by-frame composing the mapping-layer images and the selected video saved in the memory to be the output video.

2. The method according to claim 1, wherein the method is performed by firmware of an image-processing device, and the firmware implements an enhancement preprocessor for performing the enhancement preprocessing, an enhancement postprocessor for performing the enhancement post-processing, and a composer used to frame-by-frame compose the mapping-layer images and the selected video.

3. The method according to claim 1, wherein the enhancement preprocessing includes a procedure of establishing a histogram for each of the frames, performing high-dynamic-range imaging, and/or enhancing image quality.

4. The method according to claim 1, wherein the enhancement preprocessing includes the one or more image-enhancement-processing processes obtained by training image data with a neural network.

5. The method according to claim 4, wherein the one or more image-enhancement-processing processes include processes of determining a depth of each of the frames, determining objects in the frame, and/or detecting a resolution of the frame.

6. The method according to claim 1, wherein, after the mapping-layer images are aligned by a frame delay process, the selected video obtained by cropping the input video is composed with the mapping-layer images that are continuously obtained by a mapping process.

7. The method according to claim 6, wherein the method is performed by firmware of an image-processing device, and the firmware implements an enhancement preprocessor for performing the enhancement preprocessing, an enhancement postprocessor for performing the enhancement post-processing, and a composer used to frame-by-frame compose the mapping-layer images and the selected video.

8. The method according to claim 7, wherein the firmware relies on the setting of the output video to determine a scaling proportion between the images respectively processed by the enhancement preprocessor and the enhancement postprocessor.

9. The method according to claim 8, wherein the image-processing device is controlled by a controller, and the controller issues an instruction for setting up the output video.

10. The method according to claim 9, wherein the instruction enables the controller to switch the output resolution of the output video.

11. The method according to claim 7, wherein the firmware includes a pseudo timing generator that transmits a control signal to the enhancement postprocessor in advance, so that the enhancement postprocessor acquires the one or more layers of downscaled images with different reduced proportions formed in each of the frames in advance, and the enhancement post-processing is performed on the one or more layers of downscaled images.

12. An image-enhancement processing system, comprising:
an enhancement preprocessor;
an enhancement postprocessor;
a memory; and
a composer;
wherein the image-enhancement processing system performs a method for image enhancement, and the method includes:
obtaining an input video with an original resolution;
frame-by-frame cropping the input video according to setting of an output video so as to generate a selected video with an output resolution and save the selected video into the memory;
performing, by the enhancement preprocessor, enhancement preprocessing on each of frames of the selected video for forming one or more layers of downscaled images with different reduced proportions in each of the frames, and then performing one or more image-enhancement-processing processes on the one or more layers of downscaled images with different reduced proportions;
performing, by the enhancement postprocessor, enhancement post-processing according to the setting of the output video for mapping the one or more layers of downscaled images with different reduced proportions to be mapping-layer images with the output resolution; and
frame-by-frame composing, by the composer, the mapping-layer images and the selected video saved in the memory to be the output video.

13. The image-enhancement processing system according to claim 12, wherein the image-enhancement processing system is installed in an image-processing device, the image-processing device is controlled by a controller, and the controller issues an instruction for setting up the output video.

14. The image-enhancement processing system according to claim 12, wherein the enhancement preprocessing includes the one or more image-enhancement-processing processes that are obtained by training image data with a neural network.

15. The image-enhancement processing system according to claim 12, wherein, after the mapping-layer images are aligned by a frame delay process, the selected video obtained by cropping the input video is composed with the mapping-layer images that are continuously obtained by a mapping process.

16. The image-enhancement processing system according to claim 15, wherein the image-enhancement processing system relies on the setting of the output video to determine a scaling proportion between the images respectively processed by the enhancement preprocessor and the enhancement postprocessor.

17. The image-enhancement processing system according to claim 16, wherein the image-enhancement processing system is installed in an image-processing device, the image-processing device is controlled by a controller, and the controller issues an instruction for setting up the output video.

18. The image-enhancement processing system according to claim 12, further comprising a pseudo timing generator, wherein the pseudo timing generator transmits a control signal to the enhancement postprocessor in advance, so that the enhancement postprocessor acquires the one or more layers of downscaled images with different reduced proportions formed in each of the frames in advance, and the enhancement post-processing is performed on the one or more layers of downscaled images.

19. The image-enhancement processing system according to claim 18, wherein the image-enhancement processing system is installed in an image-processing device, the image-processing device is controlled by a controller, and the controller issues an instruction for setting up the output video.

20. The image-enhancement processing system according to claim 19, wherein the instruction enables the controller to switch the output resolution of the output video.
